(19) United States
(12) Patent Application Publication
(10) Pub. No.: US 2024/0166797 A1
(43) Pub. Date: May 23, 2024

(54) Cryogenic Elastomer from Ionic Liquid Epoxy

(71) Applicants: William Kaukler, Huntsville, AL (US); Christopher Henry, Huntsville, AL (US); Richard Grugel, Mountain Brook, AL (US)

(72) Inventors: William Kaukler, Huntsville, AL (US); Christopher Henry, Huntsville, AL (US); Richard Grugel, Mountain Brook, AL (US)

(21) Appl. No.: 18/056,609

(22) Filed: Nov. 17, 2022

(51) Int. Cl. C08G 59/26; C08G 59/50

(52) U.S. Cl. CPC C08G 59/26; C08G 59/504; C08G 2650/48

(57) ABSTRACT

The present disclosure is directed to an elastomer mixture formed from an ionic liquid epoxy (ILE) and a curing agent, such as T-403 polyetheramine, where the cured elastomer mixture remains tough yet rubbery and is compatible with use in cryogenic temperatures. As such, the cured elastomer is provided as one or more layer of a composite linerless storage structure for use in cryogenic environments and for storage of cryogenic fuels. The low glass transition temperature and low thermal expansion coefficient of the cured elastomer allow for resistance to micro-cracking in such conditions. Thus, the linerless composite storage structure is leak resistant. Additionally, the cured elastomer may be used as a sealant in cryogenic conditions.

### STATEMENT REGARDING FEDERALLY SPONSORED RESEARCH OR DEVELOPMENT

This invention was made with Government support under NNM12AA41C awarded by the National Aeronautics and Space Administration (NASA). The Government has certain rights in the invention.

### TECHNICAL FIELD

The present disclosure is directed to an elastomer formed from ionic liquid epoxy that exhibits ductile behavior and strength under cryogenic conditions.

### RELATED ART

Composite overwrapped pressure tanks (COPV) tanks use an aluminum shell as the liner and a carbon fiber composite to strengthen it. Should micro-cracking occur in the composite at cryogenic temperatures, the aluminum metal prevents leakage of the contents. However, aluminum is a weaker material, not insulating and heavier than the composite. Weight is a concern for such vessels when used for fuel storage in space vehicles, as higher weights require greater energy expenditures for entry into space.

Some polymer elastomeric liners have been made of foamed rubber to minimize brittleness and serve as a style of liner. Unfortunately, many such polymers become embrittled at cryogenic temperatures and most have relatively high thermal expansion coefficients. Making a hybrid construction like this has merit, but the performance and reliability of such tanks are still problematic. An alternative polymeric material that exhibits more ductile behavior at cryotemperatures is desirable not only for construction of cryotanks, but also in other materials for use in cryogenic environments, such as for use as sealants and gaskets.

### BRIEF DESCRIPTION OF DRAWINGS

The present disclosure can be better understood, by way of example only, with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a schematic representation of the process for forming the elastomeric mixture for the cured elastomer of the present disclosure.

FIG. 2 is a schematic flowchart describing the process for forming the cured elastomer of the present disclosure. The cured elastomer is useful as a cryogenic storage tank (left branch ending in step 120) and as a cryogenic sealant (right branch ending in step 126).

FIG. 3 is a scanning electron microscope (SEM) image depicting the ILE cured with T-403 and cryofractured in impact testing. A ductile energy-absorbing fracture is indicated at cryogenic temperatures.

FIG. 4 is a schematic describing the glass transition temperatures of samples of the cured elastomer of FIG. 2.

FIG. 5 is a perspective view schematic illustration of a storage tank formed using the cured elastomer of FIG. 2.

FIG. 6 is an expanded view schematic illustration of a seal between two mating surfaces formed using the cured elastomer of FIG. 2.

FIG. 7 is a graphical representation of ILE samples subjected to impact toughness testing. The front row of bars represents commercial Epon 828 resin with Huntsman T-403 curing agent. The second row represents pure ILE samples. The third row represents core-shell-rubber (CSR) additions at 3% with ILE. The fourth row represents CSR additions at 6% with ILE. The fifth row represents CSR additions at 8.8% with ILE. The sixth row represents CSR additions at 11.95% with ILE.

### DETAILED DESCRIPTION

The present disclosure is directed to an elastomeric cryogenic material and methods of manufacturing same. In one aspect of the disclosure, there is provided a method of manufacturing a cryogenic elastomer with ionic liquid epoxy (ILE) and a T-403 curing agent, although other types of curing agents are possible in other embodiments. The elastomer mixture includes an ILE composed of 1,3-bis(glycidyl)imidazolium trifluoromethanesulfonimide monomers that is not presently available commercially. The ILE and curing agent (e.g., T-403 polyetheramine) are miscible as liquids and compatible as to form the elastomer mixture when mixed and cured. The cured elastomer is resistant to micro-cracking at cryogenic temperatures and remains elastomeric at temperatures as low as −95° C. Cured storage structures formed from the cured elastomer, such as a storage tank, are configured to store cargo at cryogenic temperatures without leakage of the cargo. Further, the cryogenic elastomer is useful as a sealant that is cured at the location of structures to be sealed. The sealed structures are therefore compatible with use in a cryogenic environment.

Cryotank composite technology has adopted the use of elastomeric inner layers for cryogenic tanks, such as an aluminum liner, to reduce weight and suppress leakage due to micro-cracking that often occurs with cryo-composites. Elastomers that survive cryogenic temperatures are rare because they often crack from brittleness and thermal shock at temperatures below approximately −50 C. The ILE/T-403 combination described herein serves as a crack resistant polymeric elastomer liner for tanks made with ILE as the matrix for the structural portion of the linerless tank. At liquid nitrogen (LN₂) temperatures of about −196° C., the material demonstrates high strength and toughness.

This disclosure further relates the suitability of this new ILE formulation as a matrix polymer for carbon fiber reinforcement of the first windings of a linerless storage tank where the well-tested ILE/APB polymer is the structural composite matrix of the outer windings. The ILE/T-403 formulation can then be coated on the interior of an already cured linerless tank of ILE/APB and carbon fiber. The coated storage tank then goes through a curing treatment a second time but the thermal cycle is identical to that of the matrix and poses little risk from the high temperatures. Alternatively, the elastomeric ILE could be an unreinforced first layer of the fabricated composite layup. The inner and outer windings are co-cured to the same temperature, where slight mixing of the two epoxies is acceptable.

The elastomer mixture is also configured to seal a plurality of surfaces, such as in use as a gasket or sealant. The elastomer mixture may be cured prior to placement between mating surfaces when used as a sealing structure or fixture. Alternatively, the elastomer mixture can be applied directly to the surface or surfaces to be sealed and cured in place, thus sealing the surface or surfaces.

The terminology used herein is for the purpose of describing particular embodiments only and is not intended to be limiting. As used herein, the singular forms “a”, “an” and “the” are intended to include the plural forms as well (i.e., “at least one” of what is described), unless the context clearly indicates otherwise. In every case, use of singular articles and pronouns should be interpreted to support claims to at least one of what is described, and to support claims to exactly one of what is described.

Terms such as “at least one of A and B” should be understood to mean “only A, only B, or both A and B.” The same construction should be applied to longer list (e.g., “at least one of A, B, and C”).

As used herein, cryogenic temperatures refer to temperatures less than approximately −50° C.

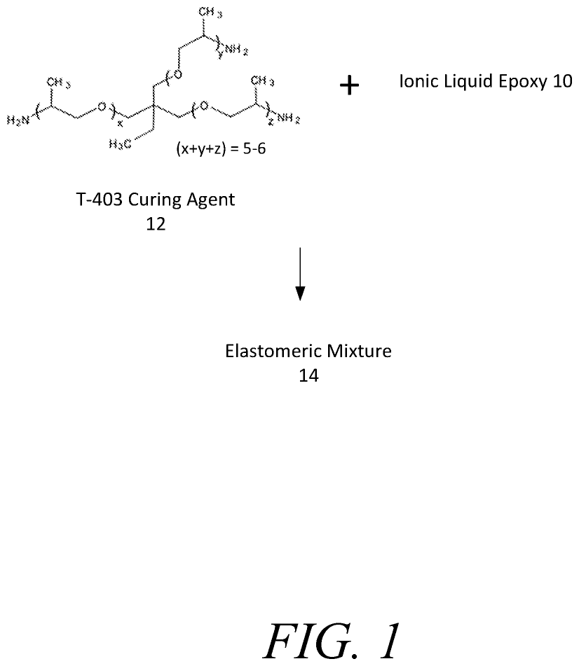

The elastomer of the present disclosure is mixed as shown in FIG. 1. Elastomer mixture 14 is formed from a mixture of an ILE 10 and a curing agent 12. Exemplary ionic liquid epoxies are described in U.S. Pat. No. 8,193,280 B2 issued on Jun. 5, 2012 and in U.S. Pat. No. 8,450,498 B2 issued on May 28, 2013, which are both incorporated herein by reference. In a preferred embodiment, ILE 10 is composed of 1,3-bi s(glycidyl)imidazolium trifluoromethanesulfonimide monomers, the synthesis of which is described in U.S. Pat. No. 8,450,498 B2. Properties of such ILE 10 cured with 4,4′-(1,3-Phenylenedioxy)dianiline (APB) include stability and toughness at temperatures ranging from room temperature to cryogenic temperatures, low thermal expansion coefficients, high post-curing strength, and no or negligible emission of volatile organic compounds. Volatility is not considered as low when curing agent 12 is a JEFFAMINE® T-403 polyetheramine curing agent (CAS Number 39423-51-3). Water permeation tests have shown that ILE 10 cured with APB has low cure shrinkage and is useful as a corrosion resistant coating. Further, ILE 10 cured with APB has low moisture and oxygen permeability, reducing the likelihood of micro-cracking during manufacture or use. These properties are an improvement over typical polymers used in composite tanks, which often fail prematurely under thermal cycling and form micro-cracks, leading to leakage. Further, even when typical polymers are increased in thickness until their weight matches that of aluminum liners, defects and leakage still occur. It is possible that moisture diffuses into typical polymers during manufacture and cryogenic fuel loading, resulting in damage at cryogenic temperatures, though the present disclosure is not beholden to such theory. ILE 10 cured with APB avoids these issues, as it has a low permeability to both hydrogen and oxygen due to its molecular structure, as well as resistance to damage from atomic oxygen and solar UV radiation. For example, ILE 10 cured with APB has been tested in a long duration space environment for exposure to space conditions for over two years, with results of little or no weight loss or structural damage.

The curing agent 12 is utilized to react with epoxy resins to create a cross-linked system. The result after curing is a “hardened” thermoset material. Curing agent 12 is any compatible agent that reacts with and cross-links the epoxy groups of ILE 10. Commercially available curing agents 12 include APB and Huntsman® JEFFAMINE® T-series agents. In preferred embodiments for creating a ductile cured elastomer 16 compatible with cryogenic temperatures, curing agent 12 is an aliphatic polyetheramine curing agent such as a JEFFAMINE® T-403 polyetheramine curing agent (CAS Number 39423-51-3). Such an exemplary curing agent 12 is shown in FIG. 1 and has amine groups located on secondary carbon atoms at ends of its aliphatic polyether chains. It further includes repeating oxypropylene units in its backbone. JEFFAMINE® T-403 has an average molecular weight of about 440 g/mol. The molecular weight of curing agent 12 should be greater than 300 g/mol in some instances, or between 300 g/mol and 4,000 g/mol. With lower molecular weight curing agents, or those with many aromatic structures, cross-linking density of the resulting cured product is too high and non-elastomeric. Further, for low molecular weight curing agents, the resulting product has a glass transition temperature too high to endure cryogenic environments without forming micro-cracks. On the other hand, higher molecular weight curing agents can have solubility issues with ILE 10.

In some instances, it is desirable to mix additives and/or diluents with ILE 10 to form elastomer mixture 14. ILE 10 is optionally diluted with a diluent to reduce production costs. Exemplary diluents include commercial epoxy, such as one from the chemical family of Bisphenol-A diglycidyl ethers (e.g., Epon 828), that are compatible ILE 10. For example, a Bis-A epoxy mixed with ILE 10 benefits from a rise in the glass transition temperature due to the addition of the Bis-A epoxy diluent, while ILE 10 remains at a high enough weight percentage to prevent micro-cracking. While a Bis-A epoxy weight percent of 50% or higher is met with poor results regarding micro-cracking in cryogenic condition, 25% Bis-A epoxy by weight produces a satisfactory matrix with ILE 10. Weight percentages of Bis-A epoxy as a diluent are approximately 5%, 8%, 9%, 10%, 15%, 20%, or 25%. In some instances, weight percentages of Bis-A epoxy as a diluent are between 25% and 50% with a loss of microcracking resistance in cryogenic temperatures and lowered fracture toughness.

The combination of ILE 10 and the T-403 cure agent has shown to be strong and tough at LN₂ temperatures. Testing at LN₂ temperatures shows that the elastomer mixture 14 of ILE 10 and T-403 curing agent in 2:1 ratio, after curing, was nearly as tough as ILE 10 with APB and core-shell rubber (CSR) additions. While a 2:1 ILE to curing agent ratio performs well for the disclosed applications herein, other mixture ratios, within 20% of this ratio are possible with toughness performance loss and moderate changes in glass transition temperature. Different ILE:curing agent ratios are possible depending on use of curing agent 12.

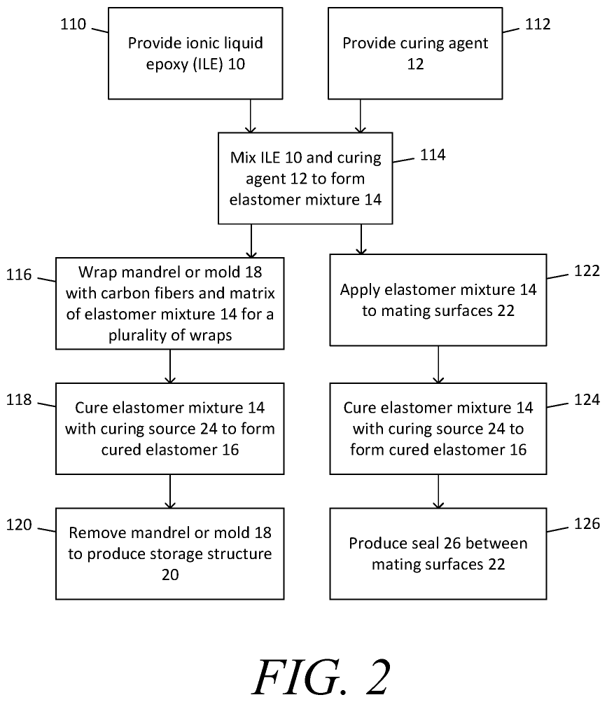

As shown in FIG. 2, ILE 10 is mixed with curing agent 12 to form elastomer mixture 14 in steps 110, 112, and 114, respectively. Mixing is performed as needed to ensure homogeneity. If additives or diluents are optionally included, they are added to elastomer mixture 14 at step 114.

Next, in steps 116, 118, and 120 elastomer mixture 14 is applied to produce a storage structure 20 that can withstand cryogenic environments. Alternatively, in steps 122, 124, and 126 elastomer mixture 14 is applied to surfaces to produce a seal 26 that is useful at cryogenic temperatures. In the first embodiment, elastomer mixture 14 is used to form storage structure 20 or other composite structure for use at cryogenic temperatures. This can be performed in several ways. In FIG. 2, storage structure 20 is formed by co-curing structure inner layer 28 and outer layer 30. However, in other instances not shown in FIG. 2, inner layer 28 is formed on pre-cured outer layer 30.

First, in step 116, a mandrel, mold 18, or other component for forming and shaping storage structure 20 is provided. In some instances, the mandrel or mold 18 is shaped so that the storage structure 20 is formed with a cylindrical or spherical shape. A spherical tank would use all helical fiber windings and have more isotropic properties. For a cylinder, hoop-shaped wrapping of fibers 32 helps storage structure 20 to withstand pressure, while helical-shaped wrapping of fibers 32 help storage structure maintain its structure and shape. An exemplary storage structure 20 produced to withstand pressures of about 1500 psi would be expected to burst at pressures of approximately 5000-6000 psi. Storage structure 20 is configured to hold approximately 10-50 liters of cargo. However, larger or smaller storage structures are possible. For a cylindrical storage structure, mandrel or mold 18 is cylindrical, and for a spherical storage structure 20, mandrel or mold 18 is spherical. In some instances, mandrel or mold 18 is a solid structure that is configured to be removed or dismantled after storage structure 20 is formed and cured. In such cases, mandrel or mold 18 is composed of a stable and strong material, such as a metal, alloy, plastic, or other relatively strong material that does not interact with inner layer 28 or outer layer 30 and does not melt or deform at curing temperatures. In some instances, mandrel or mold 18 is designed to be dissolved for removal of storage structure 20. In such cases, mandrel or mold 18 is made from ceramic and/or clay and dissolved with water and/or soap after storage structure 20 is formed and epoxies are cured. In yet other instances, mandrel or mold 18 is inflatable, such as a rubber, latex, polychloroprene, metalized plastic or nylon fabric balloon. In such cases mandrel or mold 18 is configured to be deflated and removed for storage structure removal.

Elastomer mixture 14 is used as a matrix for fibers 32, which are typically carbon fibers. However, other fiber types are possible. Exemplary carbon fibers are commercially available, such as Toray 300 or Toray 800 from Toray Carbon Fibers America in Decatur, AL, USA, or IM-7, IM-9, or IM-10 from Hexcel Corporation, Stamford, CT, USA. Alternate fibers include fiberglass and, optionally, poly-para-phenylene terephthalamide (e.g., Kevlar) fibers. Fibers 32 are specifically sized (coated) in some cases, while in others they are unsized (uncoated). It is believed that unsized fibers 32 bond well to ILE 10 due to the wetting and bond characteristics of ILE 10 that are not typically observed in other epoxies. However, there is an advantage is using smaller fiber count in carbon fiber tow employed in inner layer 28, as this reduces shear between layers of fiber 32. Fibers 32 are incorporated in a matrix of elastomer mixture 14, as shown in step 116 of FIG. 2, to produce fibers for inner layer 28.

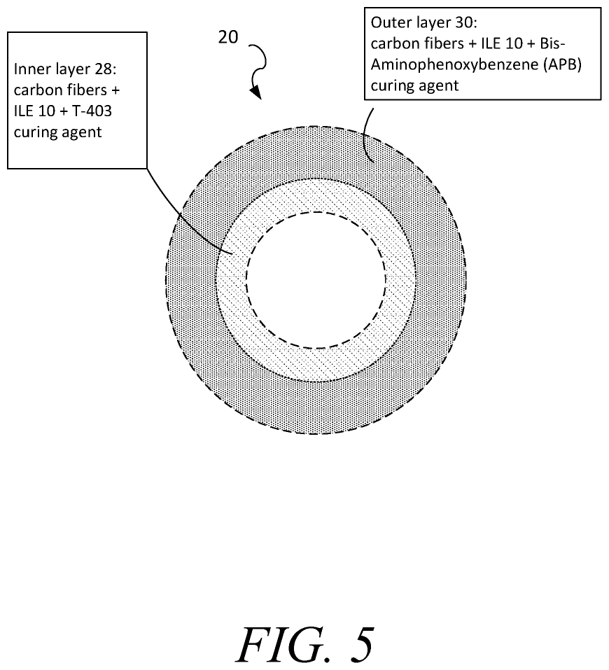

The exemplary storage structure 20 is shown in FIG. 5 with its outer layer 30 and inner layer 28. This differs from a storage tank made of one uniform material, such as composite tanks made from a typical polymer such as Bisphenol-A diglycidyl ethers (e.g., Epon 828). In such a typical tank, there are often structural issues at cryogenic temperatures that result in leakage from micro-cracks. One approach previously used to reduce leakage is to add an aluminum liner material that has a relatively high thermal expansion coefficient (aka coefficient of thermal expansion, TCE) (22 ppm for aluminum) compared to commercial polymer composites. While aluminum is also favorable due to its low density, this approach creates a dangerous delamination between the aluminum liner and the composite overwrap. Aluminum foil may be a sufficient barrier to leakage but it fails to survive the cure cycle of the composite. Using the ILE/T-403 elastomer mixture 14 described herein as the matrix of inner layer 28 allows matching with the TCE of outer layer 30 with ILE/APB, and therefore poses no threat of interlaminar shear damage from formula changes.

In FIG. 5, inner layer 28 is shown to be thinner than outer layer 30. However, layer proportions are variable based on application and may be of different ratios. Inner layer 28 prevents micro-cracking and leakage, while outer layer 30 is the main load-bearing component of storage structure 20, and any micro-cracking in outer layer 30 does not lead to cargo loss as inner layer 28 is positioned to prevent such leakage. Each layer is cured and bonded to each other so that disruptions or defects between layers are avoided or minimized.

Referring back to FIG. 2, step 116, fibers 32 with elastomer mixture 14 of ILE/T-403 are first wrapped about mandrel or mold 18 so that inner layer 28 of storage structure 20 is formed. For a 3-5 L storage structure 20, these fibers 32 are wrapped two to three times about mandrel or mold 18, in either hoop or helical wrapping patterns. Next, fibers 32 with ILE/APB for outer layer 30 are wrapped about mandrel or mold 18 on the outside of inner layer 28. For a 3-5 L storage structure 20, these fibers 32 are wrapped two to eight times about mandrel or mold 18 with inner layer 28, such that the total wraps of both inner layer fibers and outer layer fibers is approximately five to ten wraps. However, the number of wraps for inner layer 28, outer layer 30, and total number of fiber wraps vary based on the desired size of storage structure 20. As the same fiber type and tow size are used throughout, damaging shear stress is not introduced between wraps or layers. Further, bonds formed between outer layer 30 and inner layer 28 are coherent both chemically and physically, which also reduces temperature-induced damage between layers of storage structure 20.

In step 118, elastomer mixture 14 in both inner layer 28 and outer layer 30 is cured. Co-curing occurs at temperatures and times configured to completely cure all epoxies to form cured outer layer 30 and inner layer 28 with cured elastomer 16. Curing temperatures and times are known in the art. For example, curing can occur at a temperature of 100 to 200° C. for one hour to overnight. In a preferred embodiment, curing is for one to three hours at 150° C. However, other curing temperatures and times are possible, such that elastomer mixture 14 becomes cured elastomer 16. Longer curing times generally accompany lower curing temperatures, and likewise shorter curing times often accompany higher curing temperatures. Longer curing times with lower curing temperatures result in less cross-linking and a more elastomeric cured product. Conversely, shorter curing times at higher curing temperatures increase cross-linking and result in a harder cured product. Curing heat is provided by a curing source 24, which is an oven or other source of heat. However, curing may also occur in an open air environment without a dedicated heating source. Thus, heat from the immediate environment is sufficient for curing in some instances, though this may require long curing times. Following curing, mandrel or mold 18 is removed as described above.

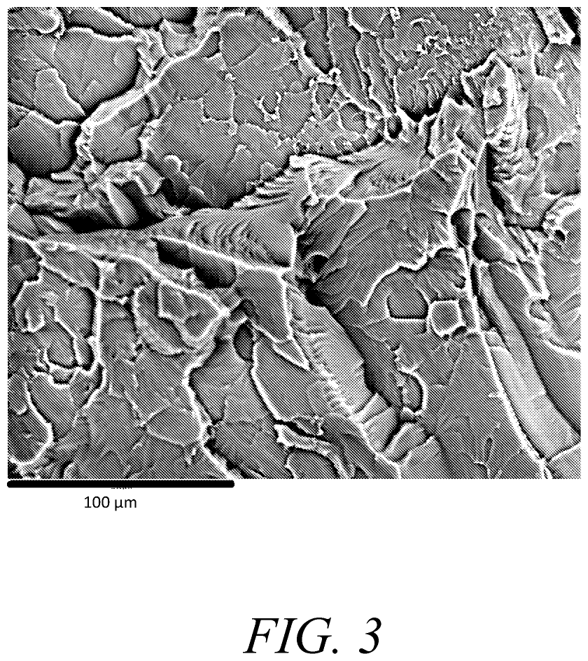

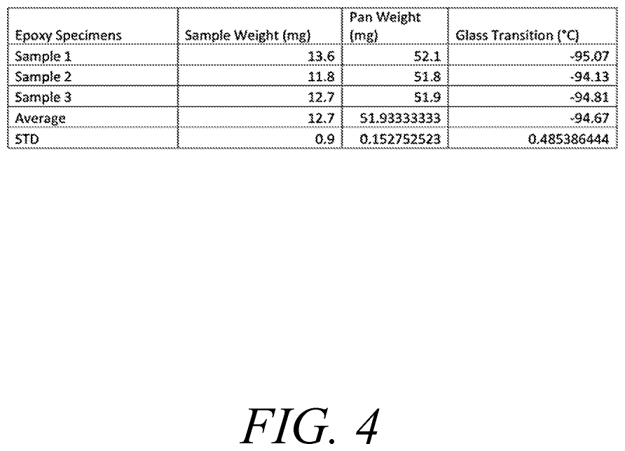

In FIG. 3, cured elastomer 16 is shown. Fractography of the impact test breaks showed an unusual level of plastic deformation. This is uncommon in polymer fractures so far below their glass transition temperatures. Here, the glass transition temperature was measured to be approximately −95 degrees Celsius, shown in FIG. 4, which puts cured elastomer 16 in a class with few other polymers, such as polytetrafluoroethylene (PTFE, Teflon™) and silicone rubber. ILE 10 with CSR has shown similar plastic deformation in fractography. PTFE, however, has creep issues because it is a thermoplastic material. Silicone rubber is often reformed to minimize structural issues. However, in reforming silicone rubber, glass transition temperature changes, though it is desirable achieve a particular glass transition temperature. Thus, minimization of structural issues with silicone rubber results in less control over glass transition temperature.

The present cured elastomer 16 has a variance in glass transition temperature of approximately ±5-10 degrees. This low glass transition temperature allows cured elastomer 16 to remain rubbery even at cryogenic temperatures. The use of particular curing agents 12, such as T-403, contribute to the low glass transition temperature. Therefore, curing agent 12 is selected with regard to maintaining a low glass transition temperature upon curing of elastomer mixture 14. Because cured elastomer 16 has a −95° C. glass transition temperature and LN₂ is approximately −195° C., cured elastomer 16 is hard below its glass transition temperature. Fractures show high energy absorption of cured elastomer 16 at LN₂ temperatures, which is not characteristic of brittle materials. Further, the TCE of elastomer mixture 14 contribute to its desirable, leak-free nature at cryogenic temperatures. Because it has a relatively low TCE, elastomer mixture 14 transitions well between room temperature and cryogenic temperatures.

Referring back to FIG. 2, steps 122, 124, and 126, elastomer mixture 14 can also be used to form a seal 26 on a surface or between mating surfaces 22. After elastomer mixture 14 is prepared, it is applied to the surface or mating surfaces 22 in step 122. The location of application is where mating surfaces 22 are to be joined, or where one surface requires seal 26 to be formed. Elastomer mixture 14 is then cured at the applied location as described above for curing of storage tank 20. Curing times and temperatures vary based on the amount and thickness of elastomer mixture 14 used, as well as the properties of mating surfaces 22. In step 126, curing is completed, leaving cured elastomer 16 to function as seal 26. When seal 26 is between mating surfaces 22, it joins and seals those surfaces.

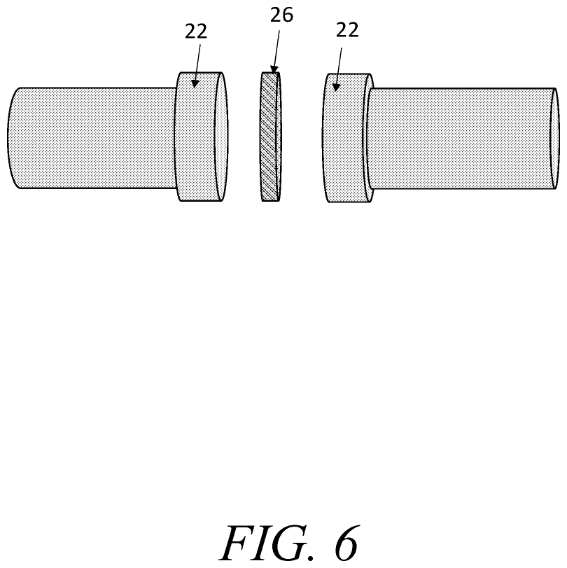

As shown in FIG. 6, seal 26 is implemented in some cases as a gasket or other sealing feature. In such a case, seal 26 may be pre-molded and pre-cured using a mold 18 and then inserted where desired in a system. Such a seal 26 is tough and elastic enough for use in space, such as in the transportation of cryogenic fluids or gasses, such as helium, argon, and xenon. Alternatively, elastomer mixture 14 is formed into a flexture hinge in other embodiments not depicted. Such a hinge is configured for deployment in space environments.

Any storage structure 20 or seal 26 formed from cured elastomer 16 is configured to withstand conditions typical of space environments and to contain and store cryogenic fuels without leakage. Storage structure 20 is configured to hold cargo, which is in some cases fuel or another liquid cargo. In particular, cargo is liquid hydrogen or liquid nitrogen fuel. When storage structure 20 is for use, storage, or transport in a space environment, it is capable of maintaining its storage integrity under these conditions. For example, in a space environment, storage structure 20 is exposed to atomic oxygen, solar ultraviolet (UV) radiation, cyclic high to low temperatures, and vacuum. Under such conditions, storage structure 20 must maintain strength and avoid leakage and corrosion. In particular, storage structure 20 or seal 26 are manufactured to avoid micro-cracking during manufacture and in a space environment. In some applications, storage structure 20 is a spacecraft tank associated with space exploration or travel, with fuel cargo that is at least partially consumed during such exploration or travel. In other applications, storage structure 20 is a storage vessel for cargo, such as cryogenic fuels, in a space environment. In some applications, storage structure 20 is a pressurized cryogenic fuel tank for use in hydrogen fueled automobiles, forklifts, and other vehicles.

As will be understood by those familiar with the art, the present invention may be embodied in other specific forms without departing from the spirit or essential characteristics thereof. Accordingly, the disclosures and descriptions herein are intended to be illustrative, but not limiting, of the scope of the invention which is set forth in the following claims.

### WORKING EXAMPLES

### Example 1

Material properties, such as strength to weight ratio and high stiffness, make carbon-fiber composites attractive for space applications such as tanks for cryogenic liquid containment. This example focuses on the problem of the fiber/epoxy interface where mismatch at cryogenic temperatures can lead to detrimental micro-cracking and leaking. (See, for example, Spain RG. Thermal micro-cracking of carbon fibre/resin composites. Composites 1971, 2(1):33-7; Hodge A J, Evaluation of micro-cracking in two carbon-fiber/epoxy matrix composite cryogenic tanks, NASA/TM-2001-211194, August 2001; and Timmerman J F, Hayes B S, Seferis J C. Cryogenic micro-cracking of carbon fiber/epoxy composites: influences of fiber-matrix adhesion. J Compos Mater November 2003; 37(21): 1939-50). Herein, a novel epoxy, 1,3-bis(glycidyl)imidazolium bis((trifluoromethyl)sulfonyl)imide (See, for example, U.S. Pat. No. 8,193,280, filed Jun. 5, 2012) is assessed for potential in making carbon fiber composites for cryogenic applications. Unlike commercial bisphenol based epoxy monomers, the ionic liquid resin is based on a unique heterocyclic imidazolium cation with a large coordinated anion. Systematic development and testing (See, for example, Rabenberg E, Brown A, Kaukler W F, Grugel R N. Results Phys 2016; 6:1185-7; Grugel R N, Hastings W C, Rabenberg E, Kaukler W F, Henry C. Results Phys 2016; 6:1188-9) of the ionic liquid epoxy (ILE) has continually shown improved cryogenic properties when compared to commercial counterparts, such that a carbon fiber composite material subjected to mechanical cycling at cryogenic temperatures does not face loss of strength or fatigue failure. Particular attention is paid to failure modes such as temperature induced embrittlement of the epoxy matrix, micro-cracking, and adhesion between the epoxy and fibers. Comparison with a traditional/commercial epoxy is made to illustrate the observed differences in behavior.

### Example 2

An ionic liquid-based epoxy was evaluated after more than two years of continual space exposure on the Materials International Space Station Experiment-8 (MISSE-8) sample rack outside of the International Space Station. In addition to the space environment the samples also experienced some 12,500 thermal cycles between approximately −40° C. and +40° C. The returned samples exhibited no cracking or de-bonding from the aluminum discs to which the epoxy was initially applied; there was a slight change in color, and a miniscule variance in before-and-after weight was measured. These are put into the context of an on-going effort to develop viable carbon-fiber based composite tanks for, but not inclusively, cryogenic liquid containment.

The MIS SE-8 was deployed on May 20, 2011 on the Shuttle Transportation System-134 (STS-134) and was retrieved Jul. 9, 2013. It was located on the Express Logistics Carrier-2 (ELC-2). The experiment consisted of two sample trays with 96 samples of various materials with the goal of determining how the space environment affected the material structure. The sample trays had two years and two months of nadir exposure (facing the earth) and experienced an oxygen fluence of 3.6±0.1×10¹⁹ atoms/cm², 12,500 cycles between approximately −40° C. and +40° C., high vacuum environment, and radiation. Four of the materials in the trays were an ionic-liquid based epoxy. The MISSE-8 sample tray was examined both pre- and post-flight, with visual observations showing no cracking or deformation of the epoxies. Further, there was a continued strong adherence of the epoxy to the aluminum base. Overall, only negligible changes in appearance and chemistry were observed. The lack of change over two years of space exposure suggests that the ionic liquid epoxy materials are well suited for use in these environments.

### Example 3

Utilizing tanks fabricated from fiber reinforced polymeric composites for storing cryogenic fluids such as liquid oxygen and liquid hydrogen is of great interest to NASA as considerable weight savings can be gained. NASA has long been interested in using carbon fiber composite tanks for cryogenic storage of fuel components such as liquid oxygen and liquid hydrogen. In particular, their high strength to weight ratio gives them a clear advantage over strictly aluminum or titanium tanks; a 20-40% weight reduction can be expected. Unfortunately, due to differential thermal expansion between the matrix and the reinforcement, such composites develop a mismatch that promotes detrimental delamination and crack growth; this is exacerbated if the component is cycled between room and cryogenic temperatures. Utilizing a formulated ionic liquid (IL) based epoxy, research shows promise to alleviate those concerns. (See, for example, Grugel R N, Kaukler W F, Paley M S, Henry C, Canaday C T, Hastings W C, Rabenberg E. Development of ionic liquid based epoxies for carbon fiber composite cryogenic tanks. In: Proceedings, NSMMS Symposium held in Huntsville, AI, 23-26 Jun. 2014). Ionic liquids are a unique class of materials; the IL epoxy herein exhibits strong ionic bonding, has a very small coefficient of thermal expansion, is hydrophobic, has an extremely low vapor pressure, and well tolerates the space environment. (See, for example, Rabenberg E, Brown A L, Kaukler W, Grugel R N. Evaluation of two ionic liquid-based epoxies from the MIS SE-8 (materials international space station experiment-8) sample carrier. In: Presentation at the American Society for Gravitational and Space Research, 2015 Annual Meeting, 11 Oct. 2015, Alexandria VA). Other attributes include good temperature stability, and low flammability, and a comparatively “greener” manufacturing process. They also are amenable to a number of other applications that can address challenges associated with achieving NASA's space exploration goals.

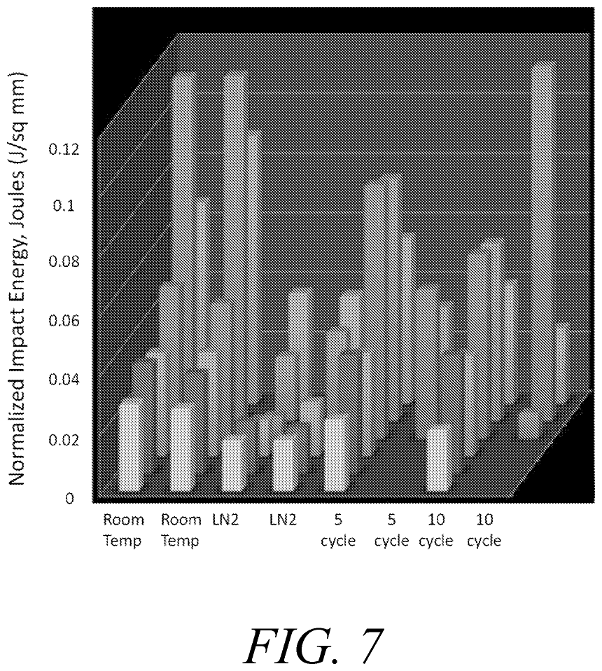

Results from Izod impact testing, which plot the energy absorbed by epoxy samples for room and liquid nitrogen (LN₂) test conditions, are shown in FIG. 7. The front row shows results from testing the commercially used Epon 828 Resin with Huntsman T-403 curing agent. The second row shows results from the unadulterated (pure) IL epoxy where improvements over the commercial product are seen both at room and LN₂ temperatures.

Adding slight additions of core-shell-rubber (CSR) significantly increases the impact toughness which appears maximized near an 8.8% addition as depicted in the fifth row of FIG. 7. Here, considerable improvements were seen at both room and LN₂ temperatures; similar results were seen for tensile samples. Finally, a number of IL-carbon fiber/cloth samples were also made and tested. Briefly, tests with LN₂, even after cycling, show no cracking or delamination; no fiber pull-out was seen on fracture surfaces.

1. A method for manufacturing a cured elastomer that resists micro-crack formation at cryogenic temperatures, the method comprising the steps of:
providing an ionic liquid epoxy (ILE) and a curing agent, the curing agent having a molecular weight greater than 300 grams per mol;
mixing the ILE and curing agent to form an elastomer mixture; and
curing the elastomer mixture at a predetermined curing temperature and curing duration to form the cured elastomer, such that the cured elastomer has a glass transition temperature of −95° C.±10° C. and such that the cured elastomer resists micro-crack formation under cryogenic temperatures.

2. The method of claim 1, wherein the ILE is composed of 1,3-bis(glycidyl)imidazolium trifluoromethanesulfonimide monomers.

3. (canceled)

4. The method of claim 1, wherein the curing agent is a T-403 polyetheramine curing agent.

5. The method of claim 1, wherein the ILE and the curing agent are mixed at a 2:1±20% ILE to curing agent ratio.

6. The method of claim 4, wherein the ILE and the curing agent are mixed at a 2:1 ILE to curing agent ratio.

7. The method of claim 1, wherein the curing temperature ranges from 100° C. to 200° C.

8. The method of claim 1, wherein the curing duration ranges from 1 hour to 3 hours.

9. A linerless composite storage structure for use at cryogenic temperatures, comprising:
an inner layer formed from wrapped fibers in a first elastomer mixture matrix, the first elastomer mixture including an ionic liquid epoxy (ILE) and a first curing agent, the first curing agent having a molecular weight greater than 300 grams per mol, such that when the first elastomer mixture is cured it has a glass transition temperature of −95° C.±10° C. and such that the inner layer is resistant to micro-cracking at cryogenic temperatures; and
an outer layer formed from wrapped fibers in a second elastomer mixture matrix, the second elastomer mixture including the ILE and a second curing agent, wherein the inner layer and the outer layer form a coherent bond at their intersection, and wherein the linerless composite storage structure is configured to store cargo at cryogenic temperatures without cargo leakage.

10. The linerless composite storage structure of claim 9, wherein the fibers are carbon fibers.

11. The linerless composite storage structure of claim 10, wherein the carbon fibers of the inner layer and carbon fibers of the outer layer are a same fiber type and tow size.

12. The linerless composite storage structure of claim 9, wherein carbon fibers are Toray 300, Toray 800, IM-7, IM-9, or IM-10 carbon fibers.

13. The linerless composite storage structure of claim 9, wherein the ILE is composed of 1,3-bis(glycidyl)imidazolium trifluoromethanesulfonimide monomers.

14. The linerless composite storage structure of claim 9, wherein the first curing agent is a T-403 polyetheramine curing agent.

15. The linerless composite storage structure of claim 9, wherein the second curing agent is an APB 4,4′-(1,3-Phenylenedioxy)dianiline curing agent.

16. A method of forming a cured elastomer seal for use at cryogenic temperatures, comprising:
providing an ionic liquid epoxy (ILE) and a curing agent, the curing agent having a molecular weight greater than 300 grams per mol;
mixing the ILE and curing agent to form an elastomer mixture;
applying the elastomer mixture to at least one surface to be sealed; and
curing the elastomer mixture at a predetermined curing temperature and curing duration to form the cured elastomer seal, such that the cured elastomer seal has a glass transition temperature of −95° C.±10° C. and such that the cured elastomer seal resists micro-crack formation under cryogenic temperatures.

17. The method of claim 16, wherein the ILE is composed of 1,3-bis(glycidyl)imidazolium trifluoromethanesulfonimide monomers and the curing agent is a T-403 polyetheramine curing agent.

18. The method of claim 16, wherein the elastomer mixture is applied to at least two surfaces to be mated, such that the cured elastomer seal joins and seals the at least two surfaces.

19. The method of claim 16, wherein the curing occurs in an ambient environment.

20. A linerless composite storage structure for use at cryogenic temperatures, comprising:
an inner layer formed from wrapped fibers in a first elastomer mixture matrix, the first elastomer mixture including an ionic liquid epoxy (ILE) and a T-403 polyetheramine curing agent, wherein the inner layer is resistant to micro-cracking at cryogenic temperatures; and
an outer layer formed from wrapped fibers in a second elastomer mixture matrix, the second elastomer mixture including the ILE and a second curing agent, wherein the inner layer and the outer layer form a coherent bond at their intersection, and wherein the linerless composite storage structure is configured to store cargo at cryogenic temperatures without cargo leakage.

21. The linerless composite storage structure of claim 9, wherein the inner layer and outer layer have matching thermal expansion coefficients, such that the coherent bond at their intersection is not subject to interlaminar shear damage.

22. The linerless composite storage structure of claim 9, wherein the cargo is pressurized cryogenic fuel for storage in space environments.

23. The method of claim 16, wherein the cured elastomer seal resists micro-crack formation in space environments.
